(19) United States
(12) Patent Application Publication
(10) Pub. No.: US 2019/0344266 A1
(43) Pub. Date: Nov. 14, 2019

(54) A METHOD AND DEVICE FOR MOVING AND DISTRIBUTING AQUEOUS LIQUIDS AT HIGH RATES ON POROUS, NONWOVEN SUBSTRATES

(71) Applicants: KIMBERLY-CLARK WORLDWIDE, INC., Neenah, WI (US); THE BOARD OF TRUSTEES OF THE UNIVERSITY OF ILLINOIS, Urbana, IL (US)

(72) Inventors: Constantine Megaridis, Oak Park, IL (US); Souvick Chatterjee, Chicago, IL (US); Uddalok Sen, Chicago, IL (US); Pallab Sinha Mahapatra, Chicago, IL (US); Ranjan Ganguly, Chicago, IL (US); Lisha Yu, Appleton, WI (US); Richard N. Dodge, Appleton, WI (US)

(73) Assignee: KIMBERLY-CLARK WORLDWIDE, INC., Neenah, WI (US)

(21) Appl. No.: 16/347,607

(22) PCT Filed: Nov. 16, 2017
(86) PCT No.: PCT/US17/61914

§ 371 Date: May 6, 2019

Related U.S. Application Data
(60) Provisional application No. 62/423,819, filed on Nov. 18, 2016.

(51) Int. Cl. B01L 3/00; B01L 3/02

(52) U.S. Cl. CPC B01L 3/502707; B01L 3/0293; B01L 3/50273; B01L 2200/021; B01L 2300/166; B01L 2300/0816; B01L 2300/089; B01L 2300/126; B01L 2200/0642

(57) ABSTRACT

A material for manipulating liquid volumes includes a porous substrate having first and second surfaces; and a liquid-manipulating pattern disposed on the first surface, the pattern having a first reservoir connected to a target point via a first wedge-shaped transport element to enable liquid transport from the target point to the first reservoir regardless of gravity, wherein the first surface is one of hydrophobic or superhydrophobic, and wherein the first wedge-shaped transport element is one of superhydrophilic when the first surface is hydrophobic, superhydrophilic when the first surface is superhydrophobic, and hydrophilic when the first surface is superhydrophobic. The pattern can include a second reservoir connected to the target point via a second wedge-shaped transport element to enable liquid transport from the target point to the second reservoir regardless of gravity.

### BACKGROUND

Liquid transport using wettability-patterned surfaces is an applicative and growing field in microfluidics. The simplicity of material fabrication combined with open-surface flow is promising for low-cost microfluidic applications. Tuning material wettability (spatially) to control liquid-solid interaction towards a specific microfluidic task is relevant not only to impervious (rigid as well as flexible) substrates, but also porous and fibrous substrates. Previous work has demonstrated unidirectional fluid transport using special coating technique that created a wettability gradient along the thickness of the fibrous substrate through selectively different exposure levels of ultraviolet (UV) radiation. The operation of such porous membrane, fabric or paper, featuring wettability gradients is dependent on the penetration resistance through such materials; this resistance arises from the coupling effect of local geometric angle of adjacent fibers and solid-liquid contact angle. The unidirectional transport is based on the fundamental observation that the penetration pressure to transport liquid from the hydrophilic to the hydrophobic side is much greater than the pressure required to force liquid in the other direction.

Functioning of these nonwoven- and paper-based devices relies heavily on how the porous substrate regulates liquid flow in a preferred direction, while inhibiting the same in the reverse direction. Classically, interaction of liquids with air and solid has been investigated as a rich three-phase contact line problem. Surface characterization rendering hydrophobicity or hydrophilicity to the substrate creates wettability patterns that provide useful applications for open-surface liquid transport. Water droplet transport on superhydrophobic tracks using external forces like gravity or electrostatic forces has been shown. Surface-tension confined tracks possess the ability to pumplessly transport low surface tension liquids without the use of an external force. While several designs have attempted to establish controlled, unidirectional liquid transport either on the surface of the fibrous substrate, or through the thickness of the porous material, combining these two modes of unidirectional transport has not been demonstrated.

### SUMMARY

Superhydrophobic and superhydrophilic patterned treatment of, for example, surge and substrate materials provides a high rate of liquid flow away from a target area. More specifically, the performance of wedge-shaped superhydrophilic tracks on a superhydrophobic background material, optionally connected with a superhydrophilic circular rim, and optionally with drainage holes or apertures in the substrate to enable liquid movement quickly through the substrate, was demonstrated. Various designs demonstrated flow rate handling capabilities from 300 to 1700 mL/min.

The technology described herein transports high volumes of a water-based liquid on the surface of the substrate and distributes the liquid down from the substrate layer at desired locations any other layer underneath. The design aims at distributing the liquid over a larger spread from the point of target (i.e., where the liquid is dispensed on the top). A wider lateral distribution of the liquid is postulated to promote faster transfer to any underlying layers. This technology helps to transport liquid radially away from the injection location faster than the standard wicking rates in nonwovens. To demonstrate this, the top surface of a substrate was patterned with spatially-selected superhydrophilic and superhydrophobic domains. The superhydrophobic zones help the surface remain dry, whereas the superhydrophilic zones facilitate liquid transport, acting as channeling locations. The shape of the superhydrophilic domains is carefully designed to ensure rapid, pumpless transport of the liquid along the top surface from the point of liquid injection radially outward over a larger dispensing area.

The present disclosure relates to a material for manipulating liquid volumes includes a porous substrate having first and second surfaces; and a liquid-manipulating pattern disposed on the first surface, the pattern having a target point, a first reservoir, and a first wedge-shaped transport element, wherein the first reservoir is connected to the target point via the first wedge-shaped transport element to enable liquid transport from the target point to the first reservoir regardless of gravity, and wherein the first wedge-shaped transport element has a wedge shape diverging from the target point to the first reservoir, wherein the first surface is one of hydrophobic or superhydrophobic, and wherein the first wedge-shaped transport element is one of a) superhydrophilic when the first surface is hydrophobic, b) superhydrophilic when the first surface is superhydrophobic, and c) hydrophilic when the first surface is superhydrophobic.

The present disclosure also relates to a material for manipulating liquid volumes includes a porous substrate having first and second surfaces; and a liquid-manipulating pattern disposed on the first surface, the pattern having a target point, first and second reservoirs, a first wedge-shaped transport element connecting the target point and the first reservoir, a second wedge-shaped transport element connecting the target point and the second reservoir, wherein each wedge-shaped transport element has a wedge shape diverging from the target point to a reservoir, and wherein each wedge-shaped transport element is configured to pass liquid from the target point to a reservoir, regardless of gravity, and a connector connecting the first and second reservoirs, wherein the first surface is one of hydrophobic or superhydrophobic, and wherein the liquid-manipulating pattern is one of a) superhydrophilic when the first surface is hydrophobic, b) superhydrophilic when the first surface is superhydrophobic, and c) hydrophilic when the first surface is superhydrophobic.

The present disclosure also relates to a material for manipulating liquid volumes includes a porous nonwoven substrate having first and second surfaces; and a liquid-manipulating pattern disposed on the first surface, the pattern having a target point, first and second reservoirs, wherein each reservoir is an aperture configured to pass liquid away from the second surface in the z-direction, a first wedge-shaped transport element connecting the target point and the first reservoir, a second wedge-shaped transport element connecting the target point and the second reservoir, wherein each wedge-shaped transport element has a wedge shape diverging from the target point to a reservoir, and wherein each wedge-shaped transport element is configured to pass liquid from the target point to a reservoir, regardless of gravity, and a connector, wherein the connector is a rim connecting the reservoirs, wherein the porous nonwoven substrate includes a hydrophobic or superhydrophobic treatment such that the first surface is one of hydrophobic or superhydrophobic, and wherein the liquid-manipulating pattern is one of a) superhydrophilic when the first surface is hydrophobic, b) superhydrophilic when the first surface is superhydrophobic, and c) hydrophilic when the first surface is superhydrophobic.

### BRIEF DESCRIPTION OF THE FIGURES

The foregoing and other features and aspects of the present disclosure and the manner of attaining them will become more apparent, and the disclosure itself will be better understood by reference to the following description, appended claims and accompanying drawings, where:

FIG. 1A is a perspective schematic view of liquid spreading and penetration on a horizontally-held substrate with a surge layer underneath the substrate where the substrate is untreated, where the flow rate is 1100 mL/min;

FIG. 1B graphically illustrates the volumetric distribution of liquid (measured over a time span of 1 second) dripping from the surge layer of FIG. 1A, where the point (0,0) denotes the location of injection, and where the gray scale bar denotes the volume collected in mL;

FIG. 2A is a perspective schematic view of liquid spreading and penetration on a horizontally-held substrate with a surge layer underneath the substrate where the substrate is a superhydrophilic substrate that has been UV-treated after being coated with TiO₂ and perfluoroalkyl methacrylate copolymer (PMC), and where the flow rate is 1100 mL/min;

FIG. 2B graphically illustrates the volumetric distribution of liquid (measured over a time span of 1 second) dripping from the surge layer of FIG. 2A, where the point (0,0) denotes the location of fluid targeting, and where the gray scale bar denotes the volume collected in mL;

FIG. 3A is a perspective schematic view of liquid spreading and penetration on a horizontally-held substrate with a surge layer underneath the substrate where the substrate is a superhydrophobic substrate that has been coated with TiO₂ and PMC, and where the flow rate is 1100 mL/min;

FIG. 3B graphically illustrates the volumetric distribution of liquid (measured over a time span of 1 second) dripping from the surge layer of FIG. 3A, where the point (0,0) denotes the location of fluid targeting, and where the gray scale bar denotes the volume collected in mL;

FIG. 4A is a perspective schematic view of a substrate held in place atop surge material, where different shapes of superhydrophilic wettable domains are formed on an otherwise superhydrophobic surface;

FIG. 4B is a perspective schematic view of the model of FIG. 4A showing a liquid targeting point and the locations of liquid dripping from the surge layer;

FIG. 5A is a plan schematic view of a four-way splitter design featuring rectangular superhydrophilic wettable tracks, each terminating at a circular end reservoir, and a small central superhydrophilic target point configured to be positioned directly below the liquid injection point;

FIG. 5B is a perspective schematic view of the pattern of FIG. 5A with liquid flowing orthogonally onto the target point at 100 mL/min;

FIG. 6A is a plan schematic view of a four-way splitter design including wedge-shaped superhydrophilic wettable tracks, each terminating at a circular end reservoir, and a small central superhydrophilic target point configured to be positioned directly below the liquid injection point;

FIG. 6B is a perspective schematic view of the pattern of FIG. 6A with liquid flowing orthogonally onto the target point at 300 mL/min;

FIG. 7A is a plan schematic view of a four-way splitter design featuring superhydrophilic wettable wedge-shaped tracks, where the substrate material has been removed from the locations occupied by end reservoirs in previous examples;

FIG. 7B is a perspective schematic view of the pattern of FIG. 7A with liquid flowing orthogonally onto the target point at 400 mL/min;

FIG. 8A is a plan schematic view of a four-way splitter design including superhydrophilic wettable wedge-shaped tracks and a superhydrophilic circular rim connecting the outward ends of the tracks;

FIG. 8B is a perspective schematic view of the pattern of FIG. 8A with liquid flowing orthogonally onto the target point at 600 mL/min;

FIG. 9 is a plan schematic view of a four-way splitter design including superhydrophilic wettable wedge-shaped tracks and a superhydrophilic circular rim connecting the outward ends of the tracks, where substrate material has been removed from locations within the circular rim;

FIG. 10A is a plan schematic view of a four-way splitter design including superhydrophilic wettable wedge-shaped tracks and a superhydrophilic elliptical rim connecting the outward ends of the tracks;

FIG. 10B is a perspective schematic view of the pattern of FIG. 10A with liquid flowing orthogonally onto the target point at 1100 mL/min;

FIG. 11A is a plan schematic view of a four-way splitter design including superhydrophilic wettable wedge-shaped tracks and a superhydrophilic elliptical rim connecting the outward ends of the tracks, where the substrate material has been removed from the locations within the elliptical rim;

FIG. 11B is a perspective schematic view of the pattern of FIG. 11A with liquid flowing orthogonally onto the target point at 1700 mL/min; and

FIG. 11C graphically illustrates the volumetric distribution of liquid (measured over a time span of 1 second) dripping from the surge layer of FIGS. 11A and 11B, where the point (0,0) denotes the location of injection, and where the color bar denotes the volume collected in mL.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION

All percentages are by weight of the total solid composition unless specifically stated otherwise. All ratios are weight ratios unless specifically stated otherwise.

The term “superhydrophobic” refers to the property of a surface to repel water very effectively. This property is quantified by a water contact angle exceeding 150°.

The term “hydrophobic,” as used herein, refers to the property of a surface to repel water with a water contact angle from about 90° to about 120°.

The term “hydrophilic,” as used herein, refers to surfaces with water contact angles well below 90°.

As used herein, the term “nonwoven web” or “nonwoven fabric” means a web having a structure of individual fibers or threads that are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters are usually expressed in microns, or in the case of staple fibers, denier. It is noted that to convert from osy to gsm, osy must be multiplied by 33.91.

As used herein the term “spunbond fibers” refers to small diameter fibers of molecularly oriented polymeric material. Spunbond fibers can be formed by extruding molten thermoplastic material as fibers from a plurality of fine, usually circular capillaries of a spinneret with the diameter of the extruded fibers then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) can be achieved by various methods including, but not limited to, those described in commonly assigned U.S. Pat. No. 6,200,669 to Marmon et al. and U.S. Pat. No. 5,759,926 to Pike et al.

Meltblown nonwoven webs are prepared from meltblown fibers. As used herein the term “meltblown fibers” means fibers formed by extruding a molten thermoplastic material through a plurality of fine, usually circular, die capillaries as molten threads or filaments into converging high velocity, usually hot, gas (e.g. air) streams that attenuate the filaments of molten thermoplastic material to reduce their diameter, which can be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers are microfibers that can be continuous or discontinuous, are generally smaller than 10 microns in average diameter (using a sample size of at least 10), and are generally tacky when deposited onto a collecting surface.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments that have been formed from at least two polymers extruded from separate extruders but spun together to form such fibers. Multicomponent fibers are also sometimes referred to as “conjugate” or “bicomponent” fibers or filaments. The term “bicomponent” means that there are two polymeric components making up the fibers. The polymers are usually different from each other, although conjugate fibers can be prepared from the same polymer, if the polymer in each state is different from the other in some physical property, such as, for example, melting point, glass transition temperature or the softening point. In all cases, the polymers are arranged in purposefully positioned distinct zones across the cross-section of the multicomponent fibers or filaments and extend continuously along the length of the multicomponent fibers or filaments. The configuration of such a multicomponent fiber can be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al. For two component fibers or filaments, the polymers can be present in ratios of 75/25, 50/50, 25/75 or any other desired ratios.

As used herein, the term “substantially continuous fibers” is intended to mean fibers that have a length that is greater than the length of staple fibers. The term is intended to include fibers that are continuous, such as spunbond fibers, and fibers that are not continuous, but have a defined length greater than about 150 millimeters.

As used herein, the term “staple fibers” means fibers that have a fiber length generally in the range of about 0.5 to about 150 millimeters. Staple fibers can be cellulosic fibers or non-cellulosic fibers. Some examples of suitable non-cellulosic fibers that can be used include, but are not limited to, polyolefin fibers, polyester fibers, nylon fibers, polyvinyl acetate fibers, and mixtures thereof. Cellulosic staple fibers include for example, pulp, thermomechanical pulp, synthetic cellulosic fibers, modified cellulosic fibers, and the like. Cellulosic fibers can be obtained from secondary or recycled sources. Some examples of suitable cellulosic fiber sources include virgin wood fibers, such as thermomechanical, bleached and unbleached softwood and hardwood pulps. Secondary or recycled cellulosic fibers can be obtained from office waste, newsprint, brown paper stock, paperboard scrap, etc., can also be used. Further, vegetable fibers, such as abaca, flax, milkweed, cotton, modified cotton, cotton linters, can also be used as the cellulosic fibers. In addition, synthetic cellulosic fibers such as, for example, rayon and viscose rayon can be used. Modified cellulosic fibers are generally composed of derivatives of cellulose formed by substitution of appropriate radicals (e.g., carboxyl, alkyl, acetate, nitrate, etc.) for hydroxyl groups along the carbon chain.

As used herein, the term “pulp” refers to fibers from natural sources, such as woody and non-woody plants. Woody plants include, for example, deciduous and coniferous trees. Non-woody plants include, for example, cotton, flax, esparto grass, milkweed, straw, jute, hemp, and bagasse.

As used herein, “tissue products” are meant to include facial tissue, bath tissue, towels, napkins, and the like. The present disclosure is useful with tissue products and tissue paper in general, including but not limited to conventionally felt-pressed tissue paper, high bulk pattern densified tissue paper, and high bulk, uncompacted tissue paper.

The objective of the technology described herein is to move liquid away from a target point to a desired location at a rate as high as 20 ml/sec or more. The technology described herein provides super-wettable and less-wettable coatings to a substrate that redirect liquid momentum and leverage Laplace pressure-driven flow due to meniscus curvatures. This ability is provided by the design of specific patterns that are a combination of hydrophobic, superhydrophobic, hydrophilic, and superhydrophilic treatments and materials of a porous substrate such as a nonwoven substrate and surge material. The specific patterns enhance the ability of a porous substrate to move and distribute liquids.

The liquid to be transported can be any liquid as long as the corresponding surface features both wettable and non-wettable domains with respect to this specific liquid. For example, the liquid can be water or alcohol. The liquid can be a refrigerant or a biological sample. The biological sample can be blood, plasma, urine, or any tissue dissolved or dispersed in a liquid or solvent. The liquid can be any biochemical agent dissolved or dispersed in a liquid solvent. Biochemical agents can include but are not limited to biomarkers, proteins, nucleic acids, pathogens, drugs, and/or toxins. The liquid can be oil or a liquid propellant. The liquid can have a high surface tension, whereby a higher surface tension corresponds to a faster transport speed. The liquid can be aqueous or non-aqueous.

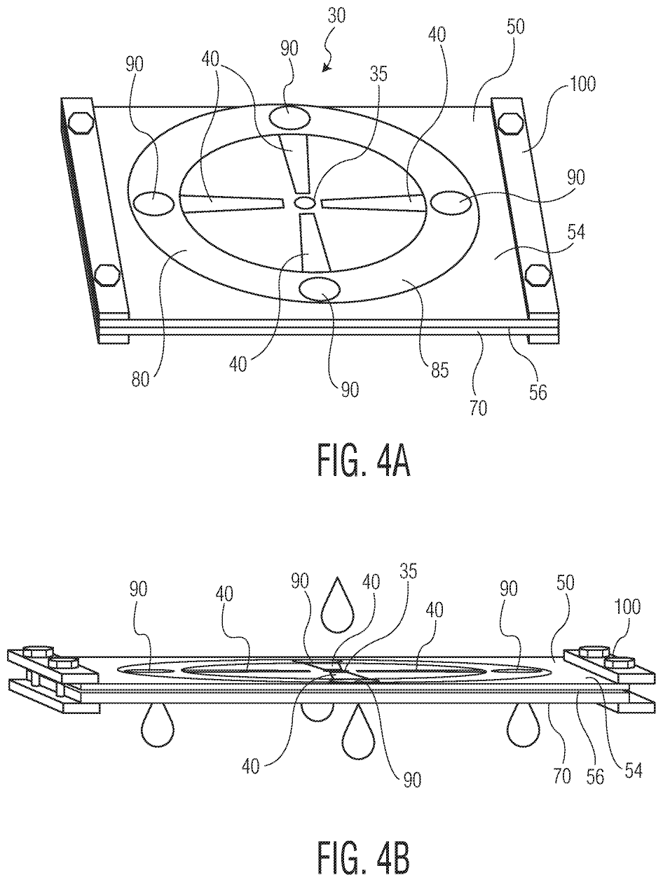

Although specific patterns are described herein as examples of various aspects, a suitable pattern 30 generally includes (as variously shown in FIGS. 4A, 4B, 5A, 6A, 7A, 8A, 9, 10A, and 11A) some combination of one or more points of liquid introduction or target points 35, wedge-shaped transport elements 40, reservoirs 60, connectors 80, rims 85, and/or apertures 90. A center or target point 35 is the location at which liquid is injected on the pattern 30. A wedge-shaped transport element 40 transports liquid from a target point 35 to a reservoir 60. A reservoir 60 is a location at which liquid collects or passes through the substrate 50, generally positioned at the outward end 45 of a wedge-shaped transport element 40 and in a location removed from the target point 35. A connector 80 is an element to provide liquid communication between reservoirs 60, and can act as an extended reservoir. In other aspects, the connector 80 can be a circular, elliptical, or other shape rim 85 providing liquid communication among some or all reservoirs 60. The pattern 30 can be symmetric or asymmetric. With the exception of the apertures 90, the pattern elements are generally hydrophilic or superhydrophilic. The specific arrangement of elements can be determined by considering the nature of the liquid to be transported.

Without committing to a specific theory, it is believed that liquid transport is aided by the hydrophobicity/hydrophilicity difference between the porous substrate 50 and the liquid-manipulating pattern 30. For example, if the porous substrate 50 is inherently or treated to be superhydrophobic, the liquid-manipulating pattern 30 can be either hydrophilic or superhydrophilic. Similarly, if the porous substrate 50 is inherently or treated to be hydrophobic, the liquid-manipulating pattern 30 should be superhydrophilic. It is not necessary for the hydrophobicity/hydrophilicity difference to be between superhydrophobicity and superhydrophilicity.

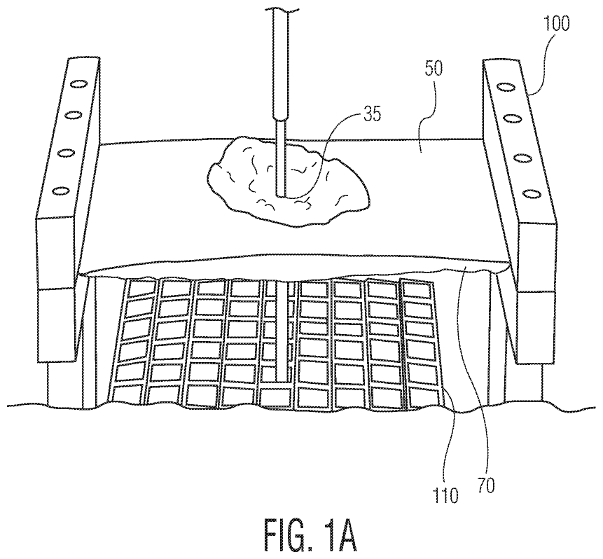

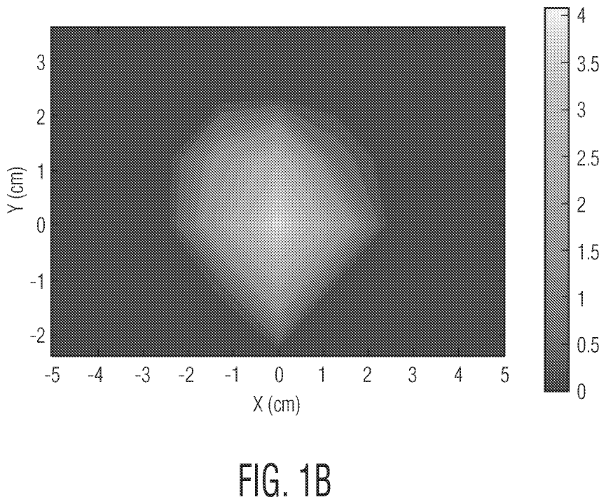

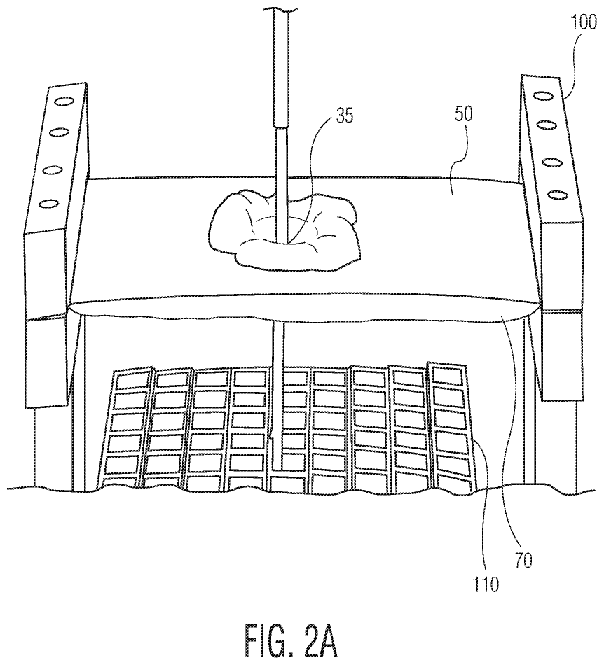

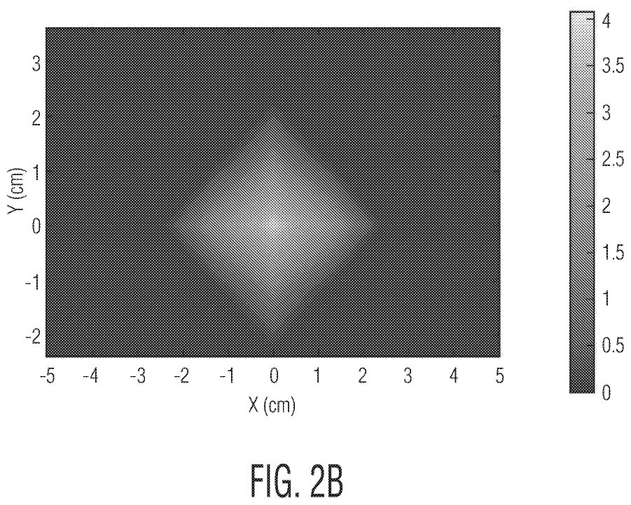

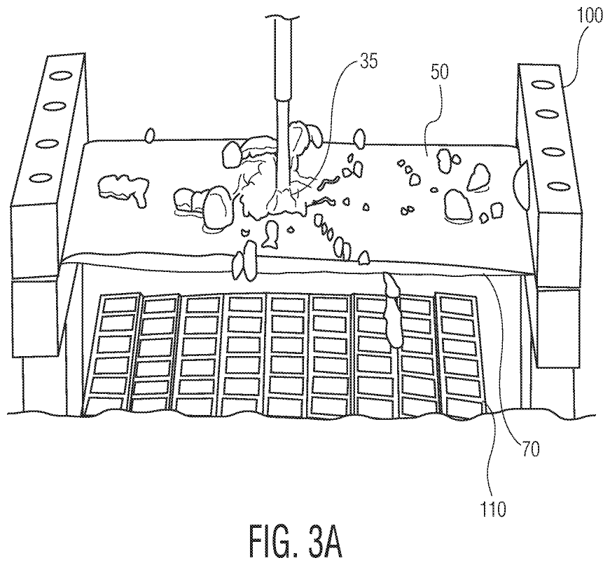

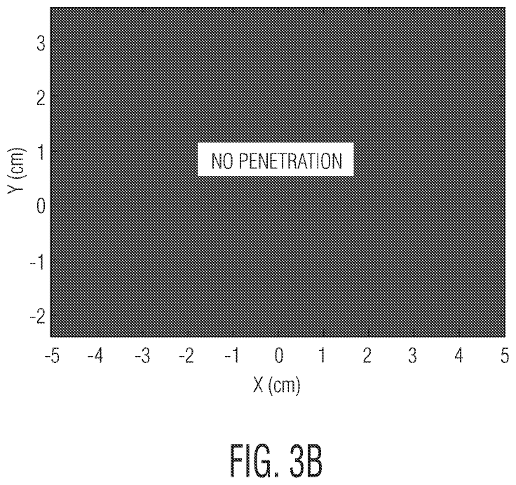

FIGS. 1A-3B demonstrate the spreading and penetration behavior of liquid dispensed on a substrate 50 with various surface modifications placed atop a surge layer 70. This arrangement offers a control case. The substrate 50 of FIGS. 1A and 1B is untreated. The substrate 50 of FIGS. 2A and 2B has been UV-treated after being coated with TiO₂ and perfluoroalkyl methacrylate copolymer (PMC), making the substrate 50 superhydrophilic. The substrate 50 of FIGS. 3A and 3B has been coated with TiO₂ and PMC, making the substrate 50 superhydrophobic. FIGS. 1B, 2B, and 3B show the volumetric liquid distribution pattern as it drips from the bottom of the surge layer 70. The liquid distribution is measured (over a time span of 1 s) by collecting the liquid that drips from the surge 70 in a patternator 110 consisting of 54 (9×6) vertically-held vials (1 cm×1 cm) as shown in FIG. 1A. The point (0,0) denotes the location of fluid targeting 35. The gray scale bar denotes the volume collected in mL.

It can be seen from FIGS. 1A-3B that the distribution of liquid on the superhydrophilic substrate 50 is more concentrated near the point of liquid introduction 35 as compared to the same obtained for the untreated substrate 50; the liquid does not penetrate in case of superhydrophobic substrate 50 (see FIG. 3B). As a result, it is demonstrated that a uniform coating (superhydrophilic or superhydrophobic) does not achieve the objective of liquid transport away from the point of target 35.

In a particular aspect, FIGS. 4A and 4B illustrate a model having two separate layers of nonwoven substrates (substrate 50 and surge 70) held together by tension applied using an end clamping fixture 100 to ensure homogeneous contact between the two layers 50, 70. The substrate 50 is coated on both surfaces 54, 56 with a nanocomposite layer rendering the surfaces superhydrophobic. Superhydrophilic regions were subsequently patterned on the top surface 54. An impinging liquid jet deposits liquid on the substrate 50 at the center or target point 35. The wettable patterns 30 on the substrate 50 cause the impinging liquid jet to be directionally transported along the superhydrophilic tracks by capillary forces and inertia.

FIG. 4A shows a typical radial spoke pattern 30 on the top surface 54 of the substrate 50. The wedge-shaped transport elements 40 are the spokes that radiate outwardly from the center or target point 35. The spokes and the circular rim 85 are superhydrophilic regions patterned on an otherwise superhydrophobic top surface 54. The pattern 30 includes apertures 90 at the terminus of each spoke where substrate material has been removed, giving liquid direct access to the surge layer 70 underneath. FIG. 4B illustrates liquid impinging the top surface 54 at the target point 35, and liquid dripping from the bottom surface of the surge layer 70 at specific points corresponding to the apertures 90 in the pattern 30 on the top surface 54 where substrate material has been removed. Details of these patterns are elaborated in the following paragraphs.

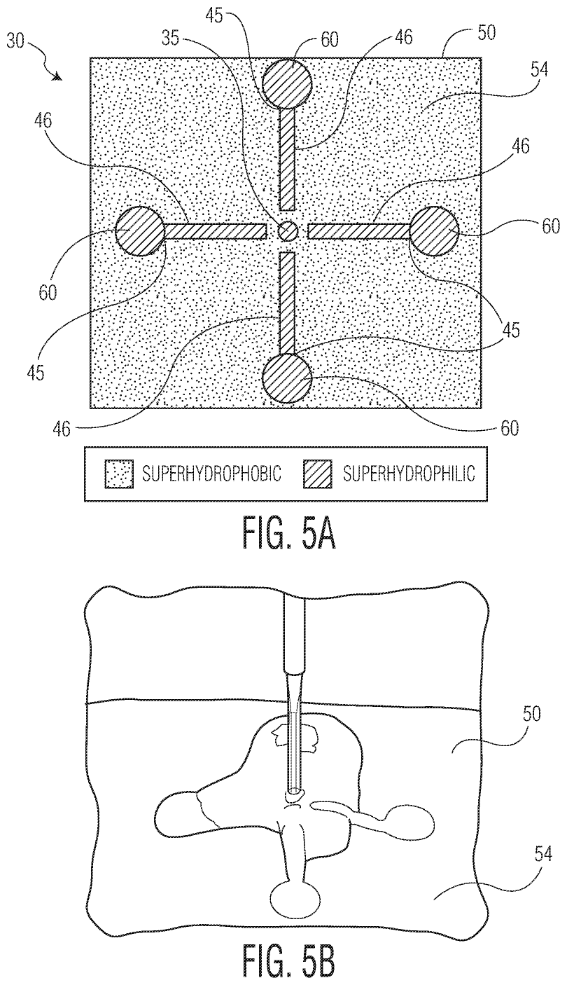

Four-way splitter with rectangular tracks: The first wettability pattern or design 30 includes four wettable rectangular tracks 46 oriented radially at right angles and extending from a central superhydrophilic target point 35 (FIG. 5A). Four circular wettable regions as end reservoirs 60 in FIG. 5A are disposed at the outward ends 45 of the tracks 46. This four-way track design helps to split the impinging jet onto the wettable tracks. A fraction of the impinging liquid penetrates through and dispenses down to the underlying layer through the central wettable circular zone. The rest of the liquid gets transported along the four wettable tracks 46 to the patterned circular end reservoirs 60. Upon reaching the reservoirs 60, the liquid penetrates vertically downward due to the porous nature of the substrate material, and eventually drips from the surface under the end reservoirs 60. This particular design is capable of handling incoming liquid flow rates up to ˜100 mL/min, where the injection Reynolds number is Re=734 and the Weber number is We=1.82. Further increases in the flow rate result in spillage of liquid over the top substrate surface 54.

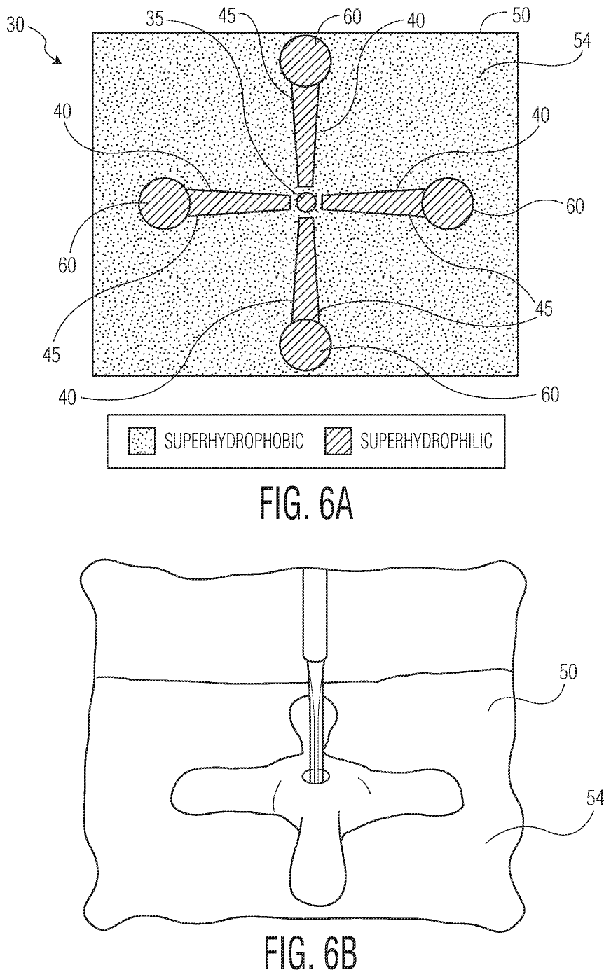

Four-way splitter with wedge-shaped tracks: To achieve a faster transport rate, the wettable rectangular tracks 46 of the design in FIG. 5A are replaced by wettable wedge-shaped tracks 40 in the design shown in FIG. 6A. Circular end reservoirs 60 are again disposed at the outward end 45 of the wedges 40. An increased liquid transport rate (compared to the rectangular tracks 46) is attained using this wedge-track design; the trapezoidal shape of the wettability contrast lines (the transition lines between the superhydrophobic and superhydrophilic regions on the substrate 50) creates an unbalanced Laplace pressure gradient along the track 40, leading to faster transport from the point of impact 35 to the end reservoirs 60. This particular design with four wedge-shaped splitters 40 is capable of handling liquid flow rates up to ˜300 mL/min with an injection Reynolds number of Re=2202 and a Weber number of We=16.4. At higher flow rates, the liquid fails to get completely absorbed in the underlying surge 70 and spills uncontrollably over the top substrate surface 54. Further improvement can be achieved with suitable modification in the track width, wedge-angle, or the size of the end reservoirs 60. Further, increasing the number of splitters 40 allows the design to handle a larger volume of liquid.

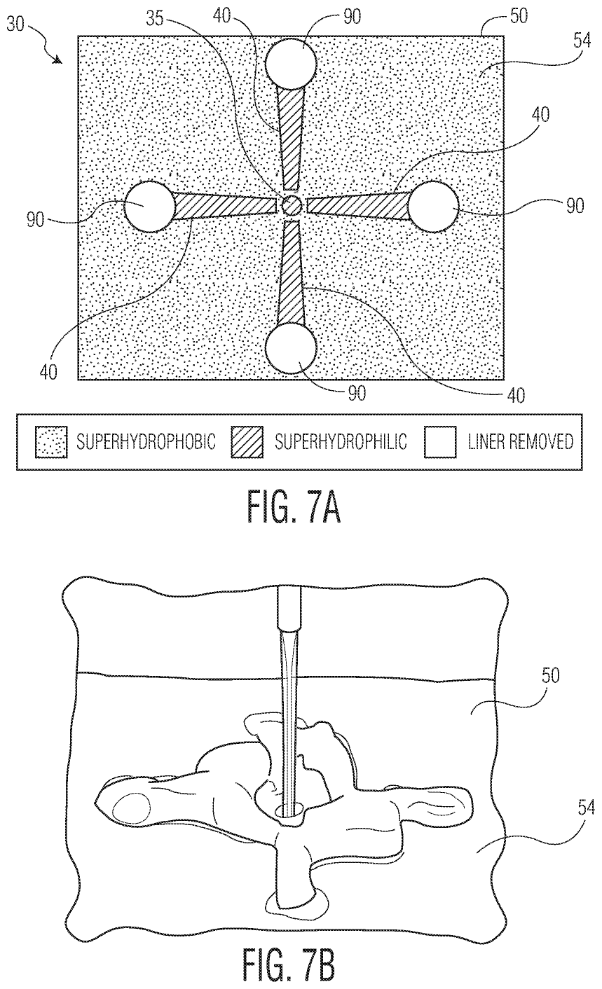

Four-way splitter with wedge-shaped tracks and punched holes (apertures) in substrate: In another design aspect shown in FIGS. 7A and 7B, the substrate material is removed where end reservoirs on the four-way splitter pattern would have been to form apertures 90. Removing the substrate material exposes the surge layer 70 underneath. This particular design eliminates the flow-rate limitation that is otherwise enforced by Darcy resistance during the vertical penetration of the liquid through the porous substrate 50. This design is capable of handling liquid injection flow rates up to ˜400 mL/min without spillage (injection Reynolds number Re=2936, Weber number We=29.2). Suitable design modifications in terms of the wedge shape and aperture size can bolster the maximum transport rate even further.

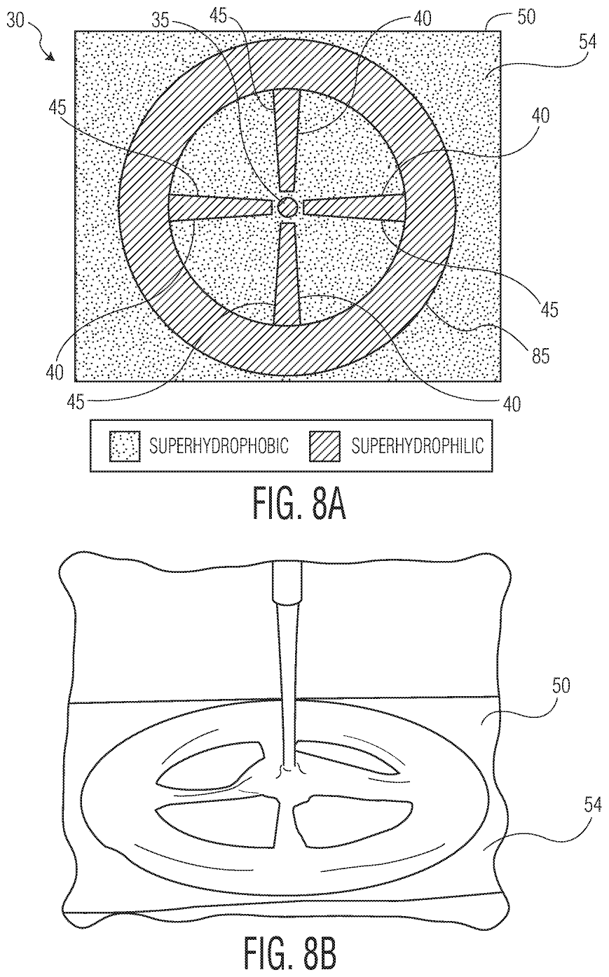

Four-way splitter with wedge-shaped tracks and circular rim: FIGS. 8A and 8B illustrate another design aspect in which a superhydrophilic circular rim 85 connects the outward ends 45 of each superhydrophilic wedge 40. This design increases the overall superhydrophilic surface area, thus increasing the liquid dispensing points. The circular rim 85 also acts as an outer boundary confining the radially-spreading liquid. The specific design shown in FIGS. 8A and 8B is capable of transporting ˜800 mL/min (injection Reynolds number Re=4404, Weber number We=65.7). Higher flow rates are possible with a wider circular rim 85 and wider wedge tracks 40.

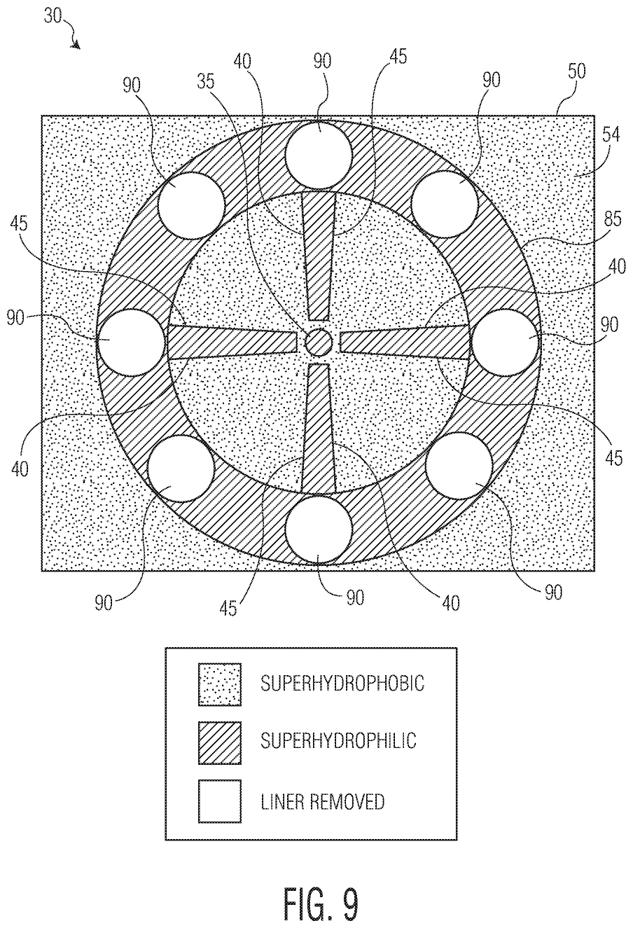

Four-way splitter with wedge-shaped tracks inside a circular rim having multiple substrate holes: FIG. 9 shows another design aspect in which the superhydrophilic circular rim 85 connects the outward ends 45 of each superhydrophilic wedge 40. The circular rim 85 also includes multiple apertures 90 where the substrate material has been removed to expose the surge layer 70 underneath. In this design, the apertures 90 reduce the Darcy resistance through the porous substrate 50, thus facilitating faster discharge past the substrate 50. This design has a measured liquid handling capability of ˜1100 mL/min. Higher flow rates are possible with further modification in the track 40, circular rim 85, and hole/aperture 90 dimensions.

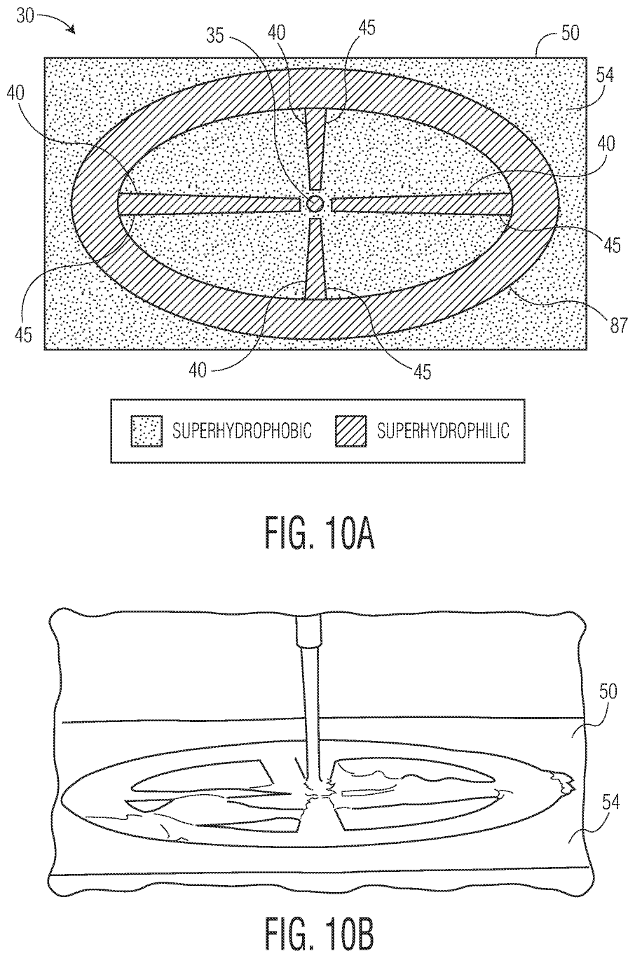

Four-way splitter with wedge-shaped tracks inside an elliptical rim: To achieve enhanced transport rates on high-aspect-ratio substrates, other design aspects can better accommodate high aspect ratios. FIGS. 10A and 10B show one such aspect, where a superhydrophilic elliptical rim 87 connects the outward ends 45 of each superhydrophilic wedge-shaped transport element 40. The objective of this design aspect is to transport liquid further along the longitudinal direction. This design incorporates the benefits of the circular rim 85 described above while at the same time distributing liquid over an area with a large aspect ratio. The design illustrated in FIG. 10A demonstrated a maximum liquid transport rate of 1200 mL/min (injection Reynolds number Re=8074, Weber number We=220.7). Further increases in flow rate are feasible with suitable modification in the dimensions of the elliptical rim 87 and the wedges 40.

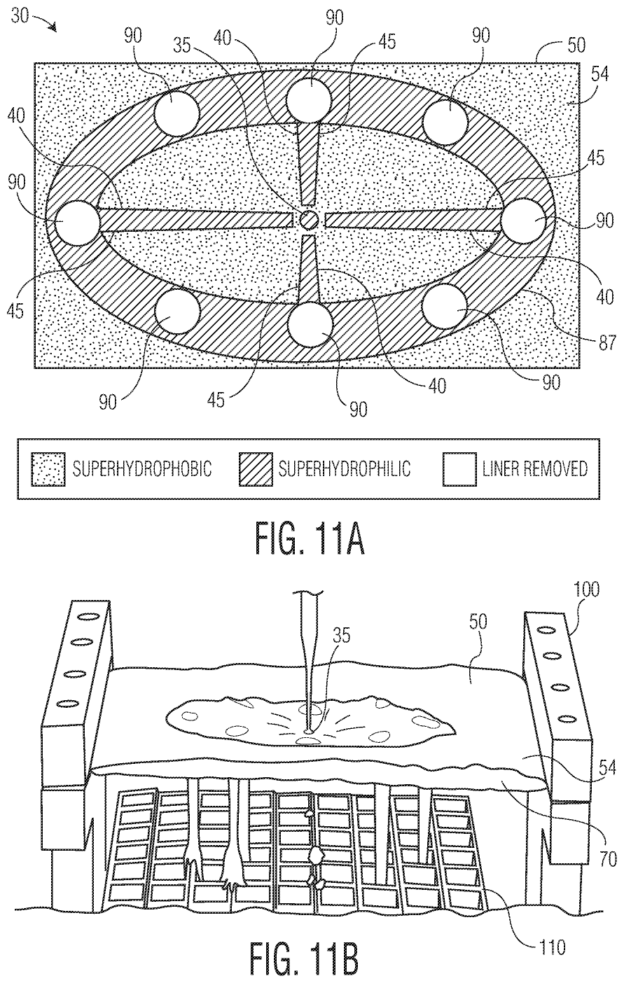

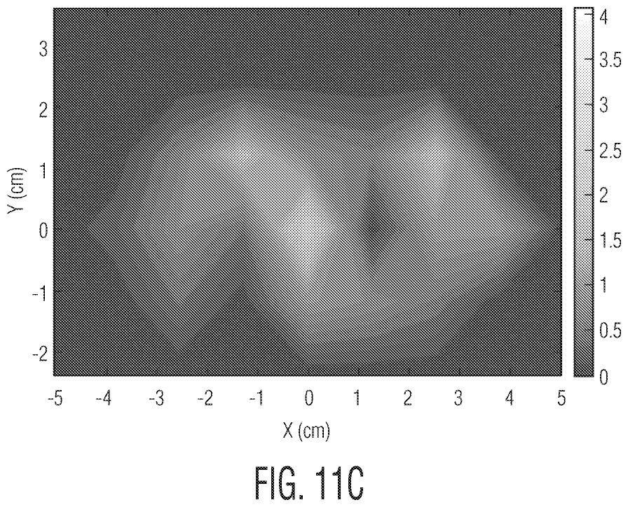

Four-way splitter with wedge-shaped tracks inside an elliptical rim with multiple holes: FIGS. 11A-11C illustrate another design aspect in which a superhydrophobic elliptical rim 87 connects the outward ends 45 of each superhydrophilic wedge 40. The elliptical rim 87 also includes multiple apertures 90 where the substrate material has been removed to expose the surge layer 70 underneath. In this design, the apertures 90 reduce the Darcy resistance through the porous substrate 50, thus facilitating faster discharge past the substrate 50. This arrangement demonstrates a liquid handling capability of 1700 mL/min (injection Reynolds number Re=8074, Weber number We=220.7). Higher flow rates are possible with further modifications in the track 40, elliptical rim 87, and aperture 90 dimensions. Volumetric distribution of liquid dripping from the bottom of the surge layer 70 is shown in FIG. 11C. Multiple dripping locations under the surge layer 70 can be seen in FIG. 11B. This arrangement produces a significantly improved liquid distribution compared to that seen with the untreated substrate (compare FIGS. 1B and 110). The horizontal spreading is about ±4 cm in this design, which is approximately double that of the untreated substrate.

In various other aspects of the present disclosure, the pattern can include any combination of the elements described herein, including multiple target points, multiple reservoirs, multiple connectors, multiple rims, concentric rims, and multiple apertures. The pattern can be symmetric or asymmetric. The specific arrangement of elements can be determined by considering the nature of the liquid to be transported.

The technology of the present disclosure enables directional liquid transport and proficient dispensing of aqueous liquid at desired locations from the surface of a nonwoven material. This technology can be used to improve the maximum absorption capability of a substrate. The technology can also be orientation-independent and can be used in the absence of gravity, such as in outer space applications. In addition, the superhydrophobic coating on the bottom surface of the substrate helps to keep the liquid inside the substrate.

In practice until recently, the fabrication of super-repellent composites requiring polymers with sufficiently low surface energies (i.e., for repelling water, γ<<72 mN/m) demanded the use of harsh solvents for wet-processing, thus hindering the development of entirely water-based systems. Fluorine-free and water-compatible polymer systems capable of delivering low surface energy have been the primary challenge for the development of truly environmentally-benign superhydrophobic coatings. A low surface energy, waterborne fluoropolymer dispersion (DuPont Capstone ST-100) was used in a water-based superhydrophobic spray, where the correlation between contact angle and hydrostatic resistance was studied, but again, the presence of fluorinated compounds in the composite still posed environmental concerns. At one point the Environmental Protection Agency (EPA) initiated a reduction in the manufacture of many dangerous fluoropolymer compounds; such compounds have a high risk of breaking down into perfluorooctanoic acids (PFOA) and can have an extremely adverse environmental impact. PFOA, a known cause of birth defects, can enter into ground water, polluting reservoirs and aquatic wild-life, eventually being ingested by humans where it can accumulate to hazardous levels. Although short-chain fluoropolymers made in response to the EPA initiative, such as DuPont's Capstone ST-100, are available and pose less environmental risk; eliminating the necessity of fluorine altogether for super-repellency has been a primary goal of this work; it is hoped that one day, such fluorinated composites can be made obsolete, being replaced by more environmentally-conscious, so-called ‘green’ alternatives.

Choosing particles having nano-scale dimensions allows for fine control over surface roughness and a greater reduction in the liquid-to-solid interfacial contact area; for hydrophobic, or low-surface energy surfaces, this translates into an increased resistance to liquid wetting by allowing the solid surface to retain pockets of vapor that limit liquid/solid contact. Many superhydrophobic surfaces fabricated in the literature have utilized hydrophobic particle fillers, necessitating the use of non-aqueous suspensions or other additives. Although these hydrophobic particles aided in generating the repellent roughness, they are not viable in a water-based system without the use of charge-stabilization or surfactants. The hydrophilic nanoparticle TiO₂ is demonstrated to supply an adequate amount of surface roughness, and is compatible with a waterborne polyolefin polymer wax blend; the polymer acts to conceal the hydrophilicity of suspended TiO₂ particles when dispersed, thus sheathing the nanoparticles in a weakly hydrophobic shell that is maintained once the final composite film has been applied and residual water is removed. Using nanoparticles of extremely small dimensions (<25 nm), a surface roughness is achieved propelling the contact angles of the final composite upwards into the superhydrophobic regime. In addition, TiO₂ has been shown to be a non-toxic additive to food, skin lotions, and paint pigments, thereby further strengthening the claim of reduced impact, environmentally or otherwise, from the composite constituents.

The superhydrophilic/superhydrophobic patterns described herein can be applied using any suitable coating formulations, including non-fluorinated formulations such as those described in PCT Patent Application Publication Nos. WO2016/138272 and WO2016/138277 and fluorinated formulations such as those described in U.S. Pat. No. 9,217,094.

The present disclosure relates to a surface of a substrate, or the substrate itself, exhibiting superhydrophobic characteristics when treated with a formulation including a hydrophobic component, a filler particle, and water. The superhydrophobicity can be applied either over the entire surface, patterned throughout or on the substrate material, and/or directly penetrated through the z-directional thickness of the substrate material.

In some aspects of the present disclosure, the substrate that is treated is a nonwoven web. In other aspects, the substrate is a tissue product.

The substrate of the present disclosure can be treated such that it is superhydrophobic throughout the z-directional thickness of the material and is controlled in such a way that only certain areas of the material are superhydrophobic. Such treatment can be designed to control spatial wettability of the material, thereby directing wetting and liquid penetration of the material; such designs can be utilized in controlling liquid transport and flow rectification.

Suitable substrates of the present disclosure can include a nonwoven fabric, woven fabric, knit fabric, or laminates of these materials. The substrate can also be a tissue or towel, as described herein. Materials and processes suitable for forming such substrate are generally well known to those skilled in the art. For instance, some examples of nonwoven fabrics that can be used in the present disclosure include, but are not limited to, spunbonded webs, meltblown webs, bonded carded webs, air-laid webs, coform webs, spunlace nonwoven webs, hydraulically entangled webs, and the like. In each case, at least one of the fibers used to prepare the nonwoven fabric is a thermoplastic material containing fiber. In addition, nonwoven fabrics can be a combination of thermoplastic fibers and natural fibers, such as, for example, cellulosic fibers (softwood pulp, hardwood pulp, thermomechanical pulp, etc.). Generally, from the standpoint of cost and desired properties, the substrate of the present disclosure is a nonwoven fabric.

If desired, the nonwoven fabric can also be bonded using techniques well known in the art to improve the durability, strength, hand, aesthetics, texture, and/or other properties of the fabric. For instance, the nonwoven fabric can be thermally (e.g., pattern bonded, through-air dried), ultrasonically, adhesively and/or mechanically (e.g. needled) bonded. For instance, various pattern bonding techniques are described in U.S. Pat. No. 3,855,046 to Hansen; U.S. Pat. No. 5,620,779 to Levy, et al.; U.S. Pat. No. 5,962,112 to Haynes, et al.; U.S. Pat. No. 6,093,665 to Sayovitz, et al.; U.S. Design Pat. No. 428,267 to Romano, et al.; and U.S. Design Pat. No. 390,708 to Brown.

In another aspect, the substrate of the present disclosure is formed from a spunbonded web containing monocomponent and/or multicomponent fibers. Multicomponent fibers are fibers that have been formed from at least two polymer components. Such fibers are usually extruded from separate extruders but spun together to form one fiber. The polymers of the respective components are usually different from each other, although multicomponent fibers can include separate components of similar or identical polymeric materials. The individual components are typically arranged in distinct zones across the cross-section of the fiber and extend substantially along the entire length of the fiber. The configuration of such fibers can be, for example, a side-by-side arrangement, a pie arrangement, or any other arrangement.

When utilized, multicomponent fibers can also be splittable. In fabricating multicomponent fibers that are splittable, the individual segments that collectively form the unitary multicomponent fiber are contiguous along the longitudinal direction of the multicomponent fiber in a manner such that one or more segments form part of the outer surface of the unitary multicomponent fiber. In other words, one or more segments are exposed along the outer perimeter of the multicomponent fiber. For example, splittable multicomponent fibers and methods for making such fibers are described in U.S. Pat. No. 5,935,883 to Pike and U.S. Pat. No. 6,200,669 to Marmon, et al.

The substrate of the present disclosure can also contain a coform material. The term “coform material” generally refers to composite materials including a mixture or stabilized matrix of thermoplastic fibers and a second non-thermoplastic material. As an example, coform materials can be made by a process in which at least one meltblown die head is arranged near a chute through which other materials are added to the web while it is forming. Such other materials can include, but are not limited to, fibrous organic materials, such as woody or non-woody pulp such as cotton, rayon, recycled paper, pulp fluff and also superabsorbent particles, inorganic absorbent materials, treated polymeric staple fibers and the like. Some examples of such coform materials are disclosed in U.S. Pat. No. 4,100,324 to Anderson, et al.; U.S. Pat. No. 5,284,703 to Everhart, et al.; and U.S. Pat. No. 5,350,624 to Georger, et al.

Additionally, the substrate can also be formed from a material that is imparted with texture on one or more surfaces. For instances, in some aspects, the substrate can be formed from a dual-textured spunbond or meltblown material, such as described in U.S. Pat. No. 4,659,609 to Lamers, et al. and U.S. Pat. No. 4,833,003 to Win, et al.

In one particular aspect of the present disclosure, the substrate is formed from a hydroentangled nonwoven fabric. Hydroentangling processes and hydroentangled composite webs containing various combinations of different fibers are known in the art. A typical hydroentangling process utilizes high pressure jet streams of water to entangle fibers and/or filaments to form a highly entangled consolidated fibrous structure, e.g., a nonwoven fabric. Hydroentangled nonwoven fabrics of staple length fibers and continuous filaments are disclosed, for example, in U.S. Pat. No. 3,494,821 to Evans and U.S. Pat. No. 4,144,370 to Boulton. Hydroentangled composite nonwoven fabrics of a continuous filament nonwoven web and a pulp layer are disclosed, for example, in U.S. Pat. No. 5,284,703 to Everhart, et al. and U.S. Pat. No. 6,315,864 to Anderson, et al.

Of these nonwoven fabrics, hydroentangled nonwoven webs with staple fibers entangled with thermoplastic fibers is especially suited as the substrate. In one particular example of a hydroentangled nonwoven web, the staple fibers are hydraulically entangled with substantially continuous thermoplastic fibers. The staple can be cellulosic staple fiber, non-cellulosic stable fibers or a mixture thereof. Suitable non-cellulosic staple fibers includes thermoplastic staple fibers, such as polyolefin staple fibers, polyester staple fibers, nylon staple fibers, polyvinyl acetate staple fibers, and the like or mixtures thereof. Suitable cellulosic staple fibers include for example, pulp, thermomechanical pulp, synthetic cellulosic fibers, modified cellulosic fibers, and the like. Cellulosic fibers can be obtained from secondary or recycled sources. Some examples of suitable cellulosic fiber sources include virgin wood fibers, such as thermomechanical, bleached and unbleached softwood and hardwood pulps. Secondary or recycled cellulosic fibers obtained from office waste, newsprint, brown paper stock, paperboard scrap, etc., can also be used. Further, vegetable fibers, such as abaca, flax, milkweed, cotton, modified cotton, cotton linters, can also be used as the cellulosic fibers. In addition, synthetic cellulosic fibers such as, for example, rayon and viscose rayon can be used. Modified cellulosic fibers are generally composed of derivatives of cellulose formed by substitution of appropriate radicals (e.g., carboxyl, alkyl, acetate, nitrate, etc.) for hydroxyl groups along the carbon chain.

One particularly suitable hydroentangled nonwoven web is a nonwoven web composite of polypropylene spunbond fibers, which are substantially continuous fibers, having pulp fibers hydraulically entangled with the spunbond fibers. Another particularly suitable hydroentangled nonwoven web is a nonwoven web composite of polypropylene spunbond fibers having a mixture of cellulosic and non-cellulosic staple fibers hydraulically entangled with the spunbond fibers.

The substrate of the present disclosure can be prepared solely from thermoplastic fibers or can contain both thermoplastic fibers and non-thermoplastic fibers. Generally, when the substrate contains both thermoplastic fibers and non-thermoplastic fibers, the thermoplastic fibers make up from about 10% to about 90%, by weight of the substrate. In a particular aspect, the substrate contains between about 10% and about 30%, by weight, thermoplastic fibers.

Generally, a nonwoven substrate will have a basis weight in the range of about 5 gsm (grams per square meter) to about 200 gsm, more typically, between about 33 gsm to about 200 gsm. The actual basis weight can be higher than 200 gsm, but for many applications, the basis weight will be in the 33 gsm to 150 gsm range.

The thermoplastic materials or fibers, making-up at least a portion of the substrate, can essentially be any thermoplastic polymer. Suitable thermoplastic polymers include polyolefins, polyesters, polyamides, polyurethanes, polyvinylchloride, polytetrafluoroethylene, polystyrene, polyethylene terephthalate, biodegradable polymers such as polylactic acid, and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(l-butene) and poly(2-butene); polypentene, e.g., poly(l-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof. These thermoplastic polymers can be used to prepare both substantially continuous fibers and staple fibers, in accordance with the present disclosure.

In another aspect, the substrate can be a tissue product. The tissue product can be of a homogenous or multi-layered construction, and tissue products made therefrom can be of a single-ply or multi-ply construction. The tissue product desirably has a basis weight of about 10 gsm to about 65 gsm, and density of about 0.6 g/cc or less. More desirably, the basis weight will be about 40 gsm or less and the density will be about 0.3 g/cc or less. Most desirably, the density will be about 0.04 g/cc to about 0.2 g/cc. Unless otherwise specified, all amounts and weights relative to the paper are on a dry basis. Tensile strengths in the machine direction can be in the range of from about 100 to about 5,000 grams per inch of width. Tensile strengths in the cross-machine direction are from about 50 grams to about 2,500 grams per inch of width. Absorbency is typically from about 5 grams of water per gram of fiber to about 9 grams of water per gram of fiber.

Conventionally pressed tissue products and methods for making such products are well known in the art. Tissue products are typically made by depositing a papermaking furnish on a foraminous forming wire, often referred to in the art as a Fourdrinier wire. Once the furnish is deposited on the forming wire, it is referred to as a web. The web is dewatered by pressing the web and drying at elevated temperature. The particular techniques and typical equipment for making webs according to the process just described are well known to those skilled in the art. In a typical process, a low consistency pulp furnish is provided from a pressurized headbox, which has an opening for delivering a thin deposit of pulp furnish onto the Fourdrinier wire to form a wet web. The web is then typically dewatered to a fiber consistency of from about 7% to about 25% (total web weight basis) by vacuum dewatering and further dried by pressing operations wherein the web is subjected to pressure developed by opposing mechanical members, for example, cylindrical rolls. The dewatered web is then further pressed and dried by a steam drum apparatus known in the art as a Yankee dryer. Pressure can be developed at the Yankee dryer by mechanical means such as an opposing cylindrical drum pressing against the web. Multiple Yankee dryer drums can be employed, whereby additional pressing is optionally incurred between the drums. The formed sheets are considered to be compacted because the entire web is subjected to substantial mechanical compressional forces while the fibers are moist and are then dried while in a compressed state.

One particular aspect of the present disclosure utilizes an uncreped through-air-drying technique to form the tissue product. Through-air-drying can increase the bulk and softness of the web. Examples of such a technique are disclosed in U.S. Pat. No. 5,048,589 to Cook, et al.; U.S. Pat. No. 5,399,412 to Sudall, et al.; U.S. Pat. No. 5,510,001 to Hermans, et al.; U.S. Pat. No. 5,591,309 to Ruqowski, et al.; U.S. Pat. No. 6,017,417 to Wendt, et al., and U.S. Pat. No. 6,432,270 to Liu, et al. Uncreped through-air-drying generally involves the steps of: (1) forming a furnish of cellulosic fibers, water, and optionally, other additives; (2) depositing the furnish on a traveling foraminous belt, thereby forming a fibrous web on top of the traveling foraminous belt; (3) subjecting the fibrous web to through-air-drying to remove the water from the fibrous web; and (4) removing the dried fibrous web from the traveling foraminous belt.

Conventional scalable methods, such as spraying, can be used to apply a superhydrophobic coating on a surface. Some technical difficulties are typically encountered when spraying water-based dispersions: The first major problem is insufficient evaporation of the fluid during atomization and a high degree of wetting of the dispersion onto the coated substrate, both resulting in non-uniform coatings due to contact line pinning and the so called “coffee-stain effect” when the water eventually evaporates. The second major challenge is the relatively large surface tension of water when compared with other solvents used for spray coating. Water, due to its high surface tension, tends to form non-uniform films in spray applications, thus requiring great care to ensure that a uniform coating is attained. This is especially critical for hydrophobic substrates where the water tends to bead and roll. It was observed that the best approach for applying the aqueous dispersions of the present disclosure was to produce extremely fine droplets during atomization, and to apply only very thin coatings, so as not to saturate the substrate and re-orient hydrogen bonding within the substrate that, after drying, would cause cellulosic substrates (e.g. paper towel) to become stiff.

In another aspect, the coatings are spray cast first on a substrate, such as standard paperboard or other cellulosic substrate; multiple spray passes are used to achieve different coating thicknesses. The sprayed films are then subjected to drying in an oven at about 80° C. for about 30 min to remove all excess water. Once dried, the coatings are characterized for wettability (i.e., hydrophobic vs. hydrophilic). The substrates can be weighed on a microbalance (Sartorius® LE26P) before and after coating and drying in order to determine the minimum level of coating required to induce superhydrophobicity. This “minimum coating” does not strictly mean that the sample will resist penetration by liquids, but rather that a water droplet will bead on the surface and roll off unimpeded. Liquid repellency of substrates before and after coating can be characterized by a hydrostatic pressure setup that determines liquid penetration pressures (in cm of liquid).

### Examples

The following is provided for exemplary purposes to facilitate understanding of the disclosure and should not be construed to limit the disclosure to the examples. Other formulations and substrates can be used within this disclosure and the claims presented below.

In a specific example, a porous substrate, 12 gsm polypropylene spunbond with 10% polypropylene SMS (Spunbond Meltblown Spunbond), was coated with TiO₂ filler particles in a hydrophobic fluoroacrylic polymer (PMC) (20 wt. % in water; DuPont, Capstone ST-100) matrix using spraying to render the substrate superhydrophobic. A facile patterning technique, which has been deployed previously on solid substrates, was adapted for the HDPT. The surface treatment includes two basic steps:
1. Spray-coating of TiO₂ nanoparticles with PMC on the substrate followed by drying in an oven (Model 10GC; Quincy Lab, Inc.) at 80° C. for 2 hours to render the substrate superhydrophobic (CA ˜153±3°).
2. Exposing the surface selectively to UV radiation (390 nm, exposure time ˜60 minutes) to render superhydrophilicity (CA<5°) on the exposed regions under a photomask.

In a first particular aspect, a material for manipulating liquid volumes includes a porous substrate having first and second surfaces; and a liquid-manipulating pattern disposed on the first surface, the pattern having a target point, a first reservoir, and a first wedge-shaped transport element, wherein the first reservoir is connected to the target point via the first wedge-shaped transport element to enable liquid transport from the target point to the first reservoir regardless of gravity, and wherein the first wedge-shaped transport element has a wedge shape diverging from the target point to the first reservoir, wherein the first surface is one of hydrophobic or superhydrophobic, and wherein the first wedge-shaped transport element is one of a) superhydrophilic when the first surface is hydrophobic, b) superhydrophilic when the first surface is superhydrophobic, and c) hydrophilic when the first surface is superhydrophobic.

A second particular aspect includes the first particular aspect, the pattern further including a second reservoir and a second wedge-shaped transport element, wherein the second reservoir is connected to the target point via the second wedge-shaped transport element to enable liquid transport from the target point to the second reservoir regardless of gravity, wherein the second wedge-shaped transport element has a wedge shape diverging from the target point to the second reservoir, and wherein the second wedge-shaped transport element is one of a) superhydrophilic when the first surface is hydrophobic, b) superhydrophilic when the first surface is superhydrophobic, and c) hydrophilic when the first surface is superhydrophobic.

A third particular aspect includes the first and/or second aspect, wherein the first and second reservoirs are connected by a connector.

A fourth particular aspect includes one or more of aspects 1-3, wherein the connector includes a hydrophilic or superhydrophilic treatment.

A fifth particular aspect includes one or more of aspects 1-4, wherein the connector is a circular rim.

A sixth particular aspect includes one or more of aspects 1-5, wherein the connector is an elliptical rim.

A seventh particular aspect includes one or more of aspects 1-6, the pattern further including a third reservoir and a third wedge-shaped transport element, wherein the third reservoir is connected to the target point via the third wedge-shaped transport element to enable liquid transport from the target point to the third reservoir regardless of gravity, wherein the third wedge-shaped transport element has a wedge shape diverging from the target point to the third reservoir, wherein the first and second reservoirs are not connected to the third reservoir by a connector, and wherein the third wedge-shaped transport element is one of a) superhydrophilic when the first surface is hydrophobic, b) superhydrophilic when the first surface is superhydrophobic, and c) hydrophilic when the first surface is superhydrophobic.

An eighth particular aspect includes one or more of aspects 1-7, wherein the liquid passed on the wedge-shaped transport element is Laplace-pressure driven.

A ninth particular aspect includes one or more of aspects 1-8, wherein the first wedge-shaped transport element and the first reservoir include a hydrophilic or superhydrophilic treatment.

A tenth particular aspect includes one or more of aspects 1-9, wherein the porous substrate includes a hydrophobic or superhydrophobic treatment.

An eleventh particular aspect includes one or more of aspects 1-10, wherein the porous substrate is a nonwoven.

A twelfth particular aspect includes one or more of aspects 1-11, wherein the reservoir is configured to pass liquid away from the second surface in the z-direction.

A thirteenth particular aspect includes one or more of aspects 1-12, wherein the reservoir is an aperture configured to pass liquid away from the second surface in the z-direction.

In a fourteenth particular aspect, a material for manipulating liquid volumes includes a porous substrate having first and second surfaces; and a liquid-manipulating pattern disposed on the first surface, the pattern having a target point, first and second reservoirs, a first wedge-shaped transport element connecting the target point and the first reservoir, a second wedge-shaped transport element connecting the target point and the second reservoir, wherein each wedge-shaped transport element has a wedge shape diverging from the target point to a reservoir, and wherein each wedge-shaped transport element is configured to pass liquid from the target point to a reservoir, regardless of gravity, and a connector connecting the first and second reservoirs, wherein the first surface is one of hydrophobic or superhydrophobic, and wherein the liquid-manipulating pattern is one of a) superhydrophilic when the first surface is hydrophobic, b) superhydrophilic when the first surface is superhydrophobic, and c) hydrophilic when the first surface is superhydrophobic.

A fifteenth particular aspect includes the fourteenth particular aspect, wherein the connector is a circular rim.

A sixteenth particular aspect includes the fourteenth and/or fifteenth aspect, wherein the connector is an elliptical rim.

A seventeenth particular aspect includes one or more of aspects 14-16, wherein the porous substrate includes a hydrophobic or superhydrophobic treatment.

An eighteenth particular aspect includes one or more of aspects 14-17, wherein the first and second reservoirs are configured to pass liquid away from the second surface in the z-direction.

A nineteenth particular aspect includes one or more of aspects 14-18, wherein the first and second reservoirs are apertures configured to pass liquid away from the second surface in the z-direction.

In a twentieth particular aspect, a material for manipulating liquid volumes includes a porous nonwoven substrate having first and second surfaces; and a liquid-manipulating pattern disposed on the first surface, the pattern having a target point, first and second reservoirs, wherein each reservoir is an aperture configured to pass liquid away from the second surface in the z-direction, a first wedge-shaped transport element connecting the target point and the first reservoir, a second wedge-shaped transport element connecting the target point and the second reservoir, wherein each wedge-shaped transport element has a wedge shape diverging from the target point to a reservoir, and wherein each wedge-shaped transport element is configured to pass liquid from the target point to a reservoir, regardless of gravity, and a connector, wherein the connector is a rim connecting the reservoirs, wherein the porous nonwoven substrate includes a hydrophobic or superhydrophobic treatment such that the first surface is one of hydrophobic or superhydrophobic, and wherein the liquid-manipulating pattern is one of a) superhydrophilic when the first surface is hydrophobic, b) superhydrophilic when the first surface is superhydrophobic, and c) hydrophilic when the first surface is superhydrophobic.

All documents cited herein are, in relevant part, incorporated herein by reference; the citation of any document is not to be construed as an admission that it is prior art with respect to the present disclosure. To the extent that any meaning or definition of a term in this document conflicts with any meaning or definition of the same term in a document incorporated by reference, the meaning or definition assigned to that term in this document shall govern.

While particular aspects of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A material for manipulating liquid volumes, the material comprising:
a porous substrate having first and second surfaces; and
a liquid-manipulating pattern disposed on the first surface, the pattern having a target point, a first reservoir, and a first wedge-shaped transport element, wherein the first reservoir is connected to the target point via the first wedge-shaped transport element to enable liquid transport from the target point to the first reservoir regardless of gravity, and wherein the first wedge-shaped transport element has a wedge shape diverging from the target point to the first reservoir,
wherein the first surface is one of hydrophobic or superhydrophobic, and wherein the first wedge-shaped transport element is one of a) superhydrophilic when the first surface is hydrophobic, b) superhydrophilic when the first surface is superhydrophobic, and c) hydrophilic when the first surface is superhydrophobic.

2. The material of claim 1, the pattern further comprising a second reservoir and a second wedge-shaped transport element, wherein the second reservoir is connected to the target point via the second wedge-shaped transport element to enable liquid transport from the target point to the second reservoir regardless of gravity, wherein the second wedge-shaped transport element has a wedge shape diverging from the target point to the second reservoir, and wherein the second wedge-shaped transport element is one of a) superhydrophilic when the first surface is hydrophobic, b) superhydrophilic when the first surface is superhydrophobic, and c) hydrophilic when the first surface is superhydrophobic.

3. The material of claim 2, wherein the first and second reservoirs are connected by a connector.

4. The material of claim 3, wherein the connector includes a hydrophilic or superhydrophilic treatment.

5. The material of claim 3, wherein the connector is a circular rim.

6. The material of claim 3, wherein the connector is an elliptical rim.

7. The material of claim 3, the pattern further comprising a third reservoir and a third wedge-shaped transport element, wherein the third reservoir is connected to the target point via the third wedge-shaped transport element to enable liquid transport from the target point to the third reservoir regardless of gravity, wherein the third wedge-shaped transport element has a wedge shape diverging from the target point to the third reservoir, wherein the first and second reservoirs are not connected to the third reservoir by a connector, and wherein the third wedge-shaped transport element is one of a) superhydrophilic when the first surface is hydrophobic, b) superhydrophilic when the first surface is superhydrophobic, and c) hydrophilic when the first surface is superhydrophobic.

8. The material of claim 1, wherein the liquid passed on the first wedge-shaped transport element is Laplace-pressure driven.

9. The material of claim 1, wherein the first wedge-shaped transport element and the first reservoir include a hydrophilic or superhydrophilic treatment.

10. The material of claim 1, wherein the porous substrate includes a hydrophobic or superhydrophobic treatment.

11. The material of claim 1, wherein the porous substrate is a nonwoven.

12. The material of claim 1, wherein the reservoir is configured to pass liquid away from the second surface in the z-direction.

13. The material of claim 1, wherein the reservoir is an aperture configured to pass liquid away from the second surface in the z-direction.

14. A material for manipulating liquid volumes, the material comprising:
a porous substrate having first and second surfaces; and
a liquid-manipulating pattern disposed on the first surface, the pattern having
a target point,
first and second reservoirs,
a first wedge-shaped transport element connecting the target point and the first reservoir,
a second wedge-shaped transport element connecting the target point and the second reservoir, wherein each wedge-shaped transport element has a wedge shape diverging from the target point to a reservoir, and wherein each wedge-shaped transport element is configured to pass liquid from the target point to a reservoir, regardless of gravity, and
a connector connecting the first and second reservoirs,
wherein the first surface is one of hydrophobic or superhydrophobic, and wherein the liquid-manipulating pattern is one of a) superhydrophilic when the first surface is hydrophobic, b) superhydrophilic when the first surface is superhydrophobic, and c) hydrophilic when the first surface is superhydrophobic.

15. The material of claim 14, wherein the connector is a circular rim.

16. The material of claim 14, wherein the connector is an elliptical rim.

17. The material of claim 14, wherein the porous substrate includes a hydrophobic or superhydrophobic treatment.

18. The material of claim 14, wherein the first and second reservoirs are configured to pass liquid away from the second surface in the z-direction.

19. The material of claim 14, wherein the first and second reservoirs are apertures configured to pass liquid away from the second surface in the z-direction.

20. A material for manipulating liquid volumes, the material comprising:
a porous nonwoven substrate having first and second surfaces; and
a liquid-manipulating pattern disposed on the first surface, the pattern having
a target point,
first and second reservoirs, wherein each reservoir is an aperture configured to pass liquid away from the second surface in the z-direction,
a first wedge-shaped transport element connecting the target point and the first reservoir,
a second wedge-shaped transport element connecting the target point and the second reservoir, wherein each wedge-shaped transport element has a wedge shape diverging from the target point to a reservoir, and wherein each wedge-shaped transport element is configured to pass liquid from the target point to a reservoir, regardless of gravity, and
a connector, wherein the connector is a rim connecting the reservoirs,
wherein the porous nonwoven substrate includes a hydrophobic or superhydrophobic treatment such that the first surface is one of hydrophobic or superhydrophobic, and wherein the liquid-manipulating pattern is one of a) superhydrophilic when the first surface is hydrophobic, b) superhydrophilic when the first surface is superhydrophobic, and c) hydrophilic when the first surface is superhydrophobic.
